(19) United States
(12) Patent Application Publication
(10) Pub. No.: US 2007/0048692 A1
(43) Pub. Date: Mar. 1, 2007

(54) Conceptual sorting ability assessment and associated methods

(76) Inventors: Sarah Leech Kemp, Tulsa, OK (US); Ursula Kirk, New York, NY (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(21) Appl. No.: 11/215,599

(22) Filed: Aug. 30, 2005

(51) Int. Cl. G09B 19/22

(52) U.S. Cl. 434/129

(57) ABSTRACT

An assessment of a subject's ability to formulate basic concepts, transfer those concepts into action, and to shift set from one concept to another measures the executive functions needed to maintain and shift set, form categories, and formulate concepts. One benefit of the present assessment is that it is nonverbal and does not require the ability to read. The assessment includes a plurality of cards, the number of cards comprising a non-prime number, containing different indicia thereon, the indicia representative of a class of real (non-abstract) objects. The indicia are sortable into a plurality of sets wherein a common feature is identified and used as the sorting criterion, with equal numbers of cards in each set. A subject is directed to make such sorts, which are then scored in order to formulate a rating of the subject's executive function.

### BACKGROUND OF THE INVENTION

1. Field of the Invention

The present invention relates to psychological assessment systems and methods, and, more particularly, to such systems and methods for assessing concept formulation ability.

2. Description of Related Art

Executive functions can be described as “multiple processing modules collected together to direct cognitive activity, including mental functions associated with the ability to engage in purposeful, organized, strategic, self-regulated, goal-directed behavior” (George McCloskey, PhD, Philadelphia College of Osteopathic Medicine). Among the executive function processes may be included (1) flexibility when shifting cognitive resources to focus on new demands or respond to new conditions or information; (2) directing the efficient use of fluid reasoning resources; and (3) the ability to shift from one concept to another.

One known test of executive functions is the Delis-Kaplan Executive Function System™ (D-KEFS™), which includes nine independent tests. One of the tests is a sorting test, in which six tokens, each having a word printed thereon, are sorted into two groups of three items according to some principle. The subject explains the principle used, and then repeats the exercise using a different principle, as many times as possible. This test measures abstract reasoning and mental flexibility.

The Wisconsin Card Sorting Test (WCST) also assesses perseveration and abstract thinking. Numbered response cards are presented that have three stimulus parameters: color, form, and numbers. Again the subject is asked to sort the cards according to different principles, and alter their approach as unannounced shifts in the sorting principle occur during test administration.

An early application of card sorting was called the “Columbia Card Sort,” which was tested in 1993 and was found to be unworkable, with results of the pilot test not having been published owing to insufficient data and the general unwieldiness of the test. The categories used in this test included “form,” “number,” “orientation,” and “other.” In another permutation of this test, the categories included “object,” “size,” and “position.”

### SUMMARY OF THE INVENTION

The present invention is directed to an assessment of a subject's ability to formulate basic concepts, transfer those concepts into action, and to shift set from one concept to another. The assessment measures the executive functions needed to maintain and shift set, form categories, and formulate concepts, which has typically been difficult to determine in young children.

One benefit of the present assessment is that it is nonverbal and does not require the ability to read.

The assessment includes a plurality of cards, the number of cards comprising a non-prime number, containing different indicia thereon, the indicia representative of a class of real (non-abstract) objects. The indicia are sortable in a plurality of ways into a plurality of sets wherein a common feature is identified and used as the sorting criterion, with equal numbers of cards in each set.

A method for assessing executive function in a subject comprises the step of presenting a subject with a plurality of display elements. Each element has a representation thereon representative of an object, and the plurality comprises a non-prime number. The display elements are sortable in a number of ways into a plurality of sets having a common feature, so that each set has an equal number of display elements. The number of ways is greater than one.

The subject is directed to sort the display elements, as many ways as possible, into a plurality of sets having a common feature. Each sort made by the subject is scored for an equality of number of display elements in each set and also for a validity of the common feature. A number of valid and equal sorts made by the subject is counted.

The assessment is stopped after one of a predetermined time and an indication by the subject that no additional sorts are possible. An executive function of the subject is rated based upon the sort-scoring and -counting steps.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 illustrates a plan view of an exemplary set of animal cards.

FIG. 2 illustrates an exemplary score sheet.

### DETAILED DESCRIPTION OF THE PREFERRED EMBODIMENTS

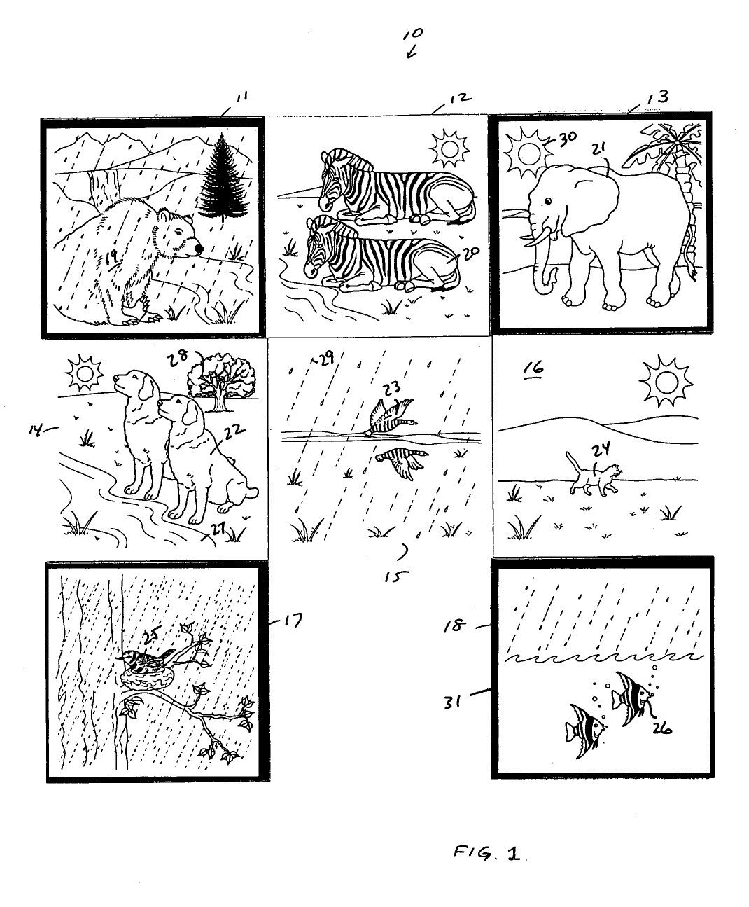

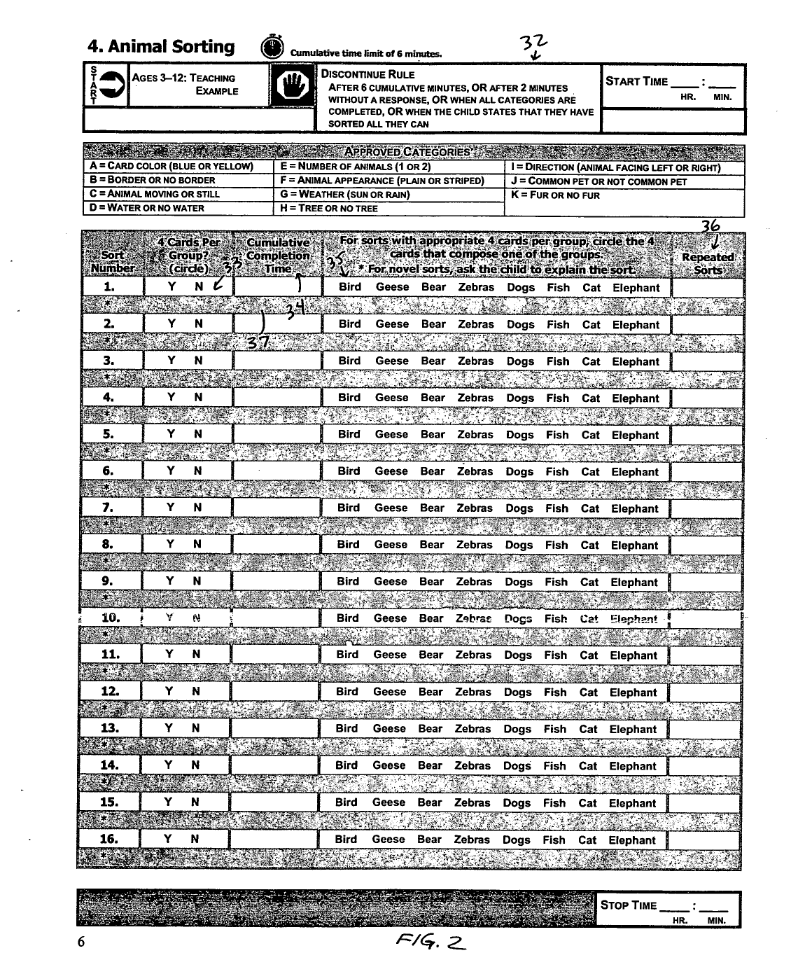

A description of the preferred embodiments of the present invention will now be presented with reference to FIGS. 1 and 2.

The assessment of the present invention includes a plurality of cards 10 (FIG. 1). In an exemplary embodiment, not intended to be limiting, a number of cards is eight. Any number could be used, so long as it was non-prime.

Each card 11-18 has a different picture thereon. Here the pictures 11-18 include one or more animals 19-26, but one of skill in the art will recognize that any class of real (non-abstract) objects could be used. The pictures 11-18 also include environmental features, such as streams 27, foliage 28, weather indicators (rain 29, sun 30) and color (4 cards are blue and 4 are yellow). The pictures 11-18, each having multiple indicia, are designed to be sortable a plurality of ways into a plurality of sets having some common feature, with equal numbers of cards in each set.

In the present example, the cards 10 are sortable into two sets of four cards each. The sorting categories for this particular exemplary set of cards 10 include: card color, border 31 or no border, animal moving or still, water or no water, number of animals (one or two), animal appearance (plain or striped), size of animal (large or small), weather (sun or rain), tree or no tree, direction (animal facing left or right), a common or uncommon pet, and presence or absence of fur.

In an exemplary embodiment, the test is administered as follows to, typically a child aged 3-16: The cards 10 are placed in front of the child in two rows of four cards each so that the child can see all the cards. The child is asked to look closely at the cards to see how they are the same and how they are different. The child is asked to sort the cards to make two groups of four cards each based upon a determined sorting criterion. The test administrator may, for example, provide a hint by placing the cards into piles according to “large” and “small” animals. The child is asked to sort the cards in as many other ways as he/she can devise, and is timed, with the cumulative time recorded as each sort is completed. The test is discontinued after 6 cumulative minutes, after 2 minutes without a response, when all categories have been completed, or when the child states that he/she has sorted in all ways he/she can.

The test administrator tracks the sorts on a form 32 such as that shown in FIG. 2. The administrator first circles “Y” or “N” 33 for the proper number of cards per group. The cumulative completion time 34 is noted, and the card identifiers 35 are circled for one of the two groups made by the child. If a sort is repeated, the last column 36 is checked. If a novel sort is made, the child may be asked the rationale in one embodiment of the invention, which is then recorded on the grey area 37 beneath the respective row. In a preferred embodiment, this step is not performed.

An executive function of the child is rated by counting the number of correct sorts made by the child, and comparing the sort count with normative data based upon factors such as, for example, the child's age.

The test of the present invention comprises a nonverbal and nonreading card sorting task that offers a reliable assessment of a child's conceptual sorting ability in a manner that does not require a reading ability, and is therefore an improvement in the art.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

What is claimed is:

1. A method for assessing executive function in a subject, the method comprising the steps of:
presenting a subject with a plurality of display elements, each element having indicia thereon representative of an object, the plurality comprising a non-prime number, the display elements sortable a number of ways into a plurality of sets having a common feature, each set having an equal number of display elements, the number of ways greater than one;
directing the subject to sort the display elements, as many ways as possible, into a plurality of sets having a common feature;
scoring each sort made by the subject for equality of number of display elements in each set;
scoring each sort made by the subject for a validity of the common feature;
counting a number of valid and equal sorts made by the subject;
stopping the assessment after one of a predetermined time and an indication by the subject that no additional sorts are possible; and
rating an executive function of the subject based upon the sort-scoring and sort-counting steps.

2. The method recited in claim 1, wherein the indicia are representative of real-world objects.

3. The method recited in claim 2, wherein the objects comprise animals.

4. The method recited in claim 3, wherein the animals are sortable into a plurality of categories.

5. The method recited in claim 3, wherein the indicia further comprise a plurality of environmental features.

6. The method recited in claim 5, wherein the environmental features are selected from a group consisting of meteorological features and geographic features.

7. The method recited in claim 3, wherein the indicia further comprise decorative elements.

8. The method recited in claim 7, wherein the decorative elements are selected from a group consisting of color and borders.

9. The method recited in claim 1, wherein the display elements comprise one of cards having the indicia imposed upon one face thereof and representations displayed on an electronic display device.

10. The method recited in claim 1, wherein the plurality of display elements comprise eight and the plurality of sets comprise two.

11. An assessment of executive function in a subject comprising:
a plurality of display elements, each element having indicia thereon representative of an object, the plurality comprising a non-prime number, the display elements sortable a number of ways into a plurality of sets having a common feature, each set having an equal number of display elements, the number of ways greater than one;
means for directing the subject to sort the display elements, as many ways as possible, into a plurality of sets having a common feature;
means for scoring each sort made by the subject for equality of number of display elements in each set;
means for scoring each sort made by the subject for a validity of the common feature;
means for counting a number of valid and equal sorts made by the subject;
means for stopping the assessment after one of a predetermined time and an indication by the subject that no additional sorts are possible; and
means for rating an executive function of the subject based upon the sort-scoring and sort-counting steps.

12. The assessment recited in claim 11, wherein the indicia are representative of real-world objects.

13. The assessment recited in claim 12, wherein the objects comprise animals.

14. The assessment recited in claim 13, wherein the animals are sortable into a plurality of categories.

15. The assessment recited in claim 13, wherein the indicia further comprise a plurality of environmental features.

16. The assessment recited in claim 15, wherein the environmental features are selected from a group consisting of meteorological features and geographic features.

17. The assessment recited in claim 13, wherein the indicia further comprise decorative elements.

18. The assessment recited in claim 17, wherein the decorative elements are selected from a group consisting of color and borders.

19. The assessment recited in claim 11, wherein the display elements comprise cards having the indicia imposed upon one face thereof.

20. The assessment recited in claim 11, further comprising a processor, a display device and an input device in signal communication with the processor, and software resident on the processor adapted to display the representations on the display device and to receive from the subject input on the display element sorts via the input device.

21. The assessment recited in claim 11, wherein the plurality of display elements comprise eight and the plurality of sets comprise two.
